(19) United States
(12) Patent Application Publication
(10) Pub. No.: US 2014/0180589 A1
(43) Pub. Date: Jun. 26, 2014

(54) METHOD AND APPARATUS FOR GENERATING MAGNETIC FIELD MAP FOR DATABASE CONSTRUCTION

(71) Applicants: Industry-Academic Cooperation Foundation, Yeungnam University, Gyeongsan-si (KR); SAMSUNG ELECTRONICS CO., LTD., Suwon-si (KR)

(72) Inventors: Yong KIM, Seoul (KR); Yong Wan PARK, Daegu (KR); Jun Yeol SONG, Daegu (KR); Soo Jung HUR, Daegu (KR)

(21) Appl. No.: 14/014,556

(22) Filed: Aug. 30, 2013

(30) Foreign Application Priority Data
Dec. 20, 2012 (KR) 10-2012-0149106

(51) Int. Cl. G01C 21/00

(52) U.S. Cl. CPC G01C 21/00
USPC 702/5

(57) ABSTRACT

Provided is a method and apparatus for generating a magnetic field map using a magnetic field value collected in a sample area. The magnetic field map may be used to verify a user location based on a geomagnetic field.

### CROSS-REFERENCE TO RELATED APPLICATION(S)

This application claims the benefit under 35 USC §119(a) of Korean Patent Application No. 10-2012-0149106, filed on Dec. 20, 2012, in the Korean Intellectual Property Office, the entire disclosure of which is incorporated herein by reference for all purposes.

### BACKGROUND

1. Field

The following description relates to a method and apparatus for generating a magnetic field map for database construction.

2. Description of Related Art

With the recent propagation of smart phones and smart devices, a user location may be estimated using a location of a device. For example, a location of a device may be determined through a network, such as a global positioning system (GPS), a wireless local area network (WLAN), a cellular network, and the like. However, these type of networks have a limitation in that an initial infrastructure is required.

Therefore, research is being conducted on technologies which are capable of determining a location of a user without the need for an initial infrastructure as is required for a WLAN network, a GPS network, a cellular network, and the like.

### SUMMARY

In an aspect, there is provided a method of generating a magnetic field map, the method including collecting a magnetic field value of a sample area comprising at least a portion of a target area, verifying a magnetic field characteristic of the sample area based on the magnetic field value of the sample area, determining a sampling interval for the target area based on the magnetic field characteristic of the sample area, collecting a magnetic field value of the target area at the sampling interval, and generating a magnetic field map based on the collected magnetic field value of the target area.

The verifying may comprise verifying the magnetic field characteristic of the sample area based on magnetic materials that are included in the sample area.

The determining may comprise determining a horizontal sampling interval and a vertical sampling interval for the target area, based on the magnetic field characteristic of the sample area.

The determining may comprise determining a collection point of a magnetic field value for the target area, based on the magnetic field characteristic of the sample area.

The method may further comprise performing an interpolation algorithm on the magnetic field value of the sample area, and predicting magnetic field values for other portions of the target area, excluding the sample area, based on the interpolation.

The generating may further comprise generating the magnetic field map based on the magnetic field values of the other portions of the target area.

The method may further comprise processing the collected magnetic field value of the target area into data that is suitable for estimating the user location, and storing the processed data in a database.

The method may further comprise correcting the collected magnetic field value of the target area based on a distribution of a magnetic permeability with respect to the target area.

The method may further comprise applying the generated magnetic field map to a map of the target area and a building plan included in the target area, and constructing a database based on a result of the applying.

The collecting of the magnetic field value of the sample area may comprise setting a point at which to collect a magnetic field value, in the sample area of the target area, and collecting the magnetic field value of the sample area at the set point.

In an aspect, there is provided non-transitory computer-readable medium comprising a program for instructing a computer to perform the method.

In an aspect, there is provided an apparatus for generating a magnetic field map, the apparatus including a first collection unit configured to collect a magnetic field value of a sample area comprising at least a portion of a target area, a processor configured to verify a magnetic field characteristic of the sample area based on the magnetic field value of the sample area, and to determine a sampling interval for the target area based on the magnetic field characteristic of the sample area, a second collection unit configured to collect a magnetic field value of the target area based on the sampling interval, and a map generating unit configured to generate a magnetic field map based on the collected magnetic field value of the target area.

The processor may be configured to verify the magnetic field characteristic of the sample area based on magnetic materials that are included in the sample area.

The processor may be configured to determine a horizontal sampling interval and a vertical sampling interval for the target area, based on the magnetic field characteristic of the sample area.

The processor may be configured to determine a collection point of a magnetic field value for the target area, based on the magnetic field characteristic of the sample area.

The processor may be configured to perform an interpolation algorithm on the magnetic field value of the sample area, and to predict magnetic field values for other portions of the target area, excluding the sample area, based on a result of the interpolation.

The map generating unit may be configured to further generate the magnetic field map based on the magnetic field values of the other areas.

The processor may be configured to process the collected magnetic field value of the target area into data that is suitable for estimating the user location, and to store the processed data in a database.

The processor may be configured to correct the collected magnetic field value of the target area based on a distribution of a magnetic permeability with respect to the target area.

The apparatus may further comprise a database (DB) constructing unit configured to apply the generated magnetic field map to a map of the target area and a building plan included in the target area, and to construct a database based on a result of the applying.

Other features and aspects will be apparent from the following detailed description, the drawings, and the claims.

### BRIEF DESCRIPTION OF THE DRAWINGS

FIG. 1 is a diagram illustrating an example of a method of generating a magnetic field map.

FIG. 2 is a diagram illustrating an example of a scheme of collecting a magnetic field value of a sample area.

FIGS. 3A and 3B are graphs illustrating an example of a sampling interval for a target area.

FIG. 4 is a diagram illustrating an example of a magnetic field map.

FIG. 5 is a diagram illustrating an example of a method of constructing a DB based on a magnetic field value of a target area.

FIG. 6 is a diagram illustrating an example of a method of estimating a location of a user terminal using a magnetic field map.

FIG. 7 is a diagram illustrating an example of an apparatus for generating a magnetic field map.

FIG. 8 is a diagram illustrating another example of an apparatus for generating a magnetic field map.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

As described herein, a user terminal may refer to electronic devices that are capable of estimating a location of a terminal, for example, using a magnetic sensor, an inertial measurement unit (IMU) sensor, and the like. Examples of electronic devices include a laptop computer, a personal digital assistant (PDA), a plasma display panel (PDP), a pad, a tablet, a smart phone, a BlackBerry, a feature phone, a navigation device, and the like.

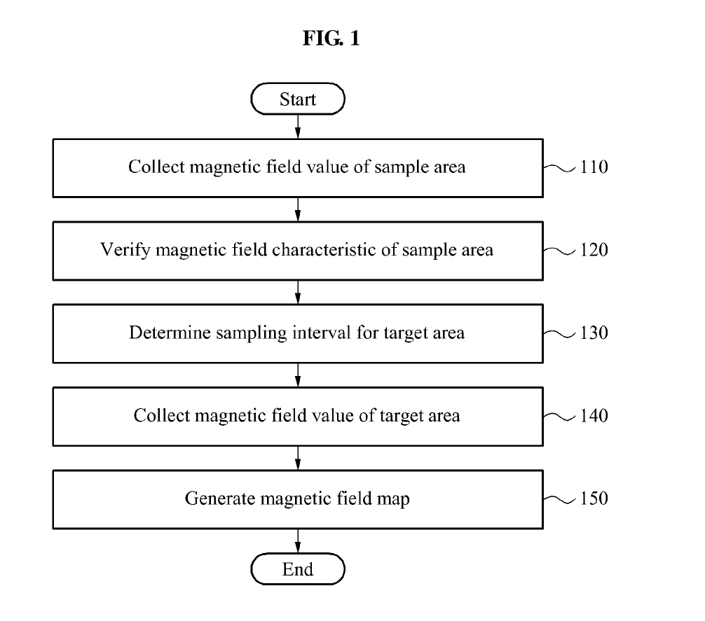

FIG. 1 illustrates an example of a method of generating a magnetic field map. The methods described herein may be performed by an apparatus for generating a magnetic field map such as a terminal or an apparatus included in a terminal.

Referring to FIG. 1, in 110, a magnetic field value of a sample area corresponding to at least a portion of a target area is collected. For example, the target area is an area for verifying a user location based on a geomagnetic field. In addition, the collecting of the magnetic field may refer to both of the generating apparatus measuring the magnetic field value directly, for example, using a geomagnetic sensor, an IMU sensor, and the like, or the generating apparatus obtaining a magnetic field value measured by an external geomagnetic sensor, an external IMU sensor, and the like.

In 120, a magnetic field characteristic of the sample area is verified using the magnetic field value of the sample area. For example, the magnetic field characteristic of the sample area may be verified based on a distribution of magnetic materials in and around the sample area. Examples of magnetic materials in and around an area include piping, stairs, beams, rods, and other materials with magnetic properties that would affect magnetic field. In some examples, the generating apparatus may apply an interpolation algorithm to the magnetic field value of the sample area, and predict magnetic field values of other areas of the target area, excluding the sample area. Here, the predicted magnetic field values of the other areas may be used for generating a magnetic field map, along with a magnetic field value of the target area. Accordingly, magnetic field characteristics of the target area can be collected and verified.

In 130, a sampling interval for the target area is determined based on the magnetic field characteristic of the sample area. For example, the generating apparatus may determine a horizontal sampling interval and a vertical sampling interval for the target area, based on the magnetic field characteristic of the sample area. As another example, the generating apparatus may determine a collection point of a magnetic field value for the target area, based on the magnetic field characteristic of the sample area.

In 140, a magnetic field of the target area is collected based on the sampling interval determined in 130. For example, the magnetic field value of the target area may be collected in a form of a three-axial value of (x, y, z), that is, the magnetic field in two-dimensional space or in three-dimensional space. The magnetic field value of the target area collected in 140 may be processed into data suitable for estimating the user location, and the processed data may be stored in a DB. For example, the generating apparatus may correct the collected magnetic field value of the target area, based on a distribution of a magnetic permeability with respect to the target area.

In 150, the generating apparatus generates a magnetic field map for DB construction, using the collected magnetic field value of the target area. For example, the predicted magnetic field values of the other areas may also be used for generating the magnetic field map, in addition to a magnetic field value of the target area collected in 140.

According to various aspects, the generating apparatus may associate the magnetic field map generated in 150 with a map of the target area and a plan of a building included in the target area, and construct the DB, based on a result of the associating.

The constructed DB may be used for a fingerprint algorithm which is a probabilistic modeling method, among location estimating schemes. In addition, the magnetic field values of other points may be predicted by applying various interpolation algorithms to the magnetic field value actually obtained when the DB is constructed. For example, the interpolation algorithms may include cubic convolution interpolation, spline interpolation, and the like.

The scheme using the fingerprint algorithm may be a scheme of estimating a location based on probabilistic modeling. The scheme may utilize noise and surrounding environment information as information for the location estimation, and may be used most commonly for a wireless local area network (WLAN) based location estimating system.

However, the scheme using the fingerprint algorithm may be enhanced through DB construction in order to perform location estimation. For example, in order to configure an accurate DB, collecting actual geomagnetic field values, for example, geomagnetic field intensities, in all spaces for location estimation may be performed. Accordingly, magnetic field values of other areas or other points may be predicted by applying an interpolation algorithm to actual geomagnetic field values obtained when the DB is constructed. In this example, the DB may be constructed without installation of a new infrastructure, and an amount of time to be used to construct the DB may be reduced.

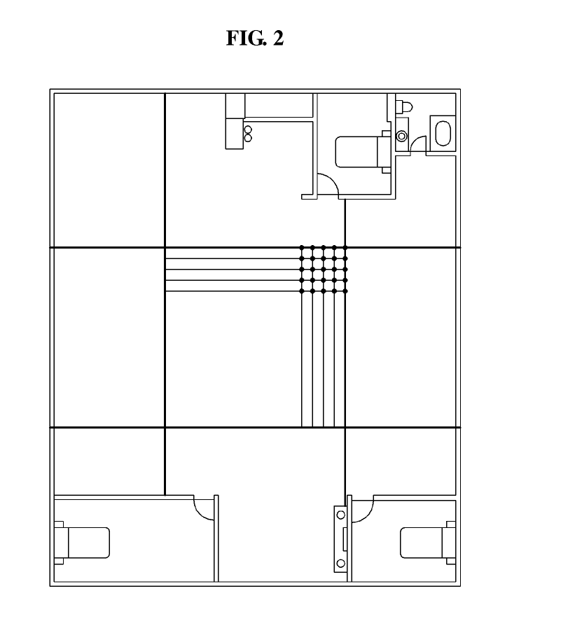

FIG. 2 illustrates an example of a scheme of collecting a magnetic field value of a sample area. In this example, the sample area corresponds to at least a portion of a target area.

Among global environmental information, a geomagnetic field or an intensity of a magnetic field may be an excellent resource for location estimation that satisfies accuracy, constancy, and universal necessity for location estimation. For example, geomagnetic field may have an error range of less than 10 meters (m).

The geomagnetic field may form a magnetic field distribution change based on a crustal structure, for example, a strata, underground minerals, underground water, and the like. However, when a distribution of a magnetic permeability is not uniform, a geomagnetic to disturbance may occur such that a distribution of a magnetic flux density may not be uniform. For example, in a building that is built using steel bars, steel frames, and the like, a local geomagnetic disturbance may occur due to the steel bars, the steel frames, and the like which bear ferromagnetism. The local geomagnetic disturbance may be tens of times to thousands of times greater than a geomagnetic disturbance caused by solar wind.

A value or an intensity of the geomagnetic field is a force applied to a unit magnetic pole at which the geomagnetic field is static, and may be divided into three components, for example, a declination, an inclination, and a total magnetic intensity, for analysis. However, the value of the geomagnetic field may not be invariable, but may be changed periodically or irregularly. Accordingly, the value of the geomagnetic field may be used, in view of interference effects with respect to various variables.

For example, to use a location estimating scheme based on a geomagnetic field value, location estimation may be performed by a fingerprint scheme, among probabilistic modeling schemes of estimating a location using a signal intensity. However, as described above, the location estimating scheme using probabilistic modeling may require DB construction in order to perform the location estimation.

An accuracy of the location estimation using the fingerprint scheme may be closely related to selection of dense location estimation points in a DB. For example, geomagnetic values or intensities may be obtained at narrow intervals in order to increase an accuracy of location estimation for a case in which indoor location estimation is performed using a magnetic field sensor. In this example, when a similarity of geomagnetic values is common, a location error may be significant.

Accordingly, the generating apparatus may collect a magnetic field value, in view of factors affecting a change in a geomagnetic value. For example, the factors may include a location estimation height, story identification, a time, and the like of a sample area, for example, a sixth story, corresponding to at least a portion of a target area, for example, an inside of a single building, as shown in FIG. 2.

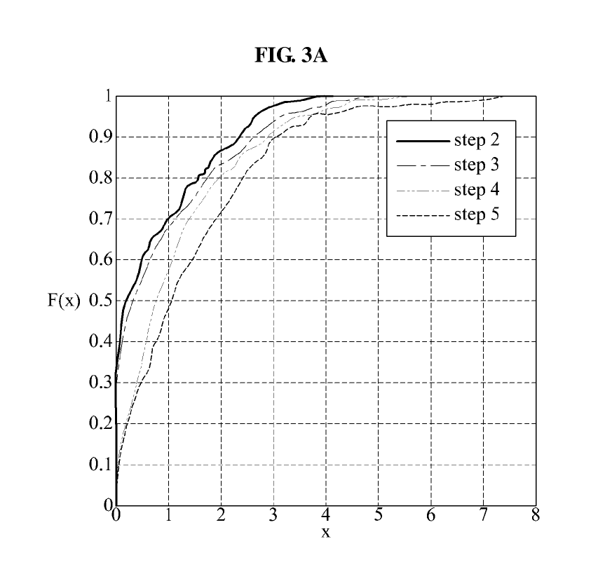

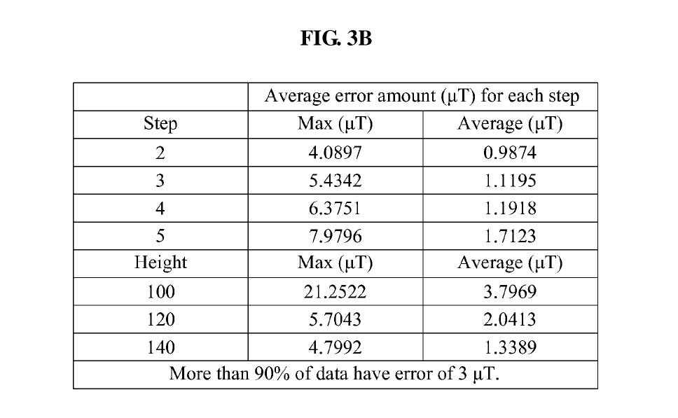

FIGS. 3A and 3B illustrate examples of determining a sampling interval for a target area.

For example, the generating apparatus may establish a relationship between a change in a magnetic field value and magnetic materials in a building, by analyzing a magnetic field value or a geomagnetic intensity measured in a sample area of the building. The generating apparatus may verify geomagnetic values according to positions and structures of the magnetic materials, based on the relationship between the change in the magnetic field value and the magnetic materials. The generating apparatus may determine a sampling interval or a collection point of a magnetic field value, with respect to the building.

According to various aspects, a magnetic field characteristic of the sample area may vary depending on, for example, a horizontal size of a target space, a vertical height of the target space, a structural characteristic of the target space, an indoor space arrangement, a measurement time, a measurement height of a sensor, and the like. As an example, the structural characteristic of the target space may include a room, a lobby, a passage, and the like.

Accordingly, the sampling interval for the target area may be determined, by verifying the magnetic field characteristic of the sample area, and determining measurement factors satisfying an accuracy within an average error range based on the verified magnetic field characteristic. For example, the accuracy may be within an average error range of 1 M where M is a change in magnetic field.

In particular, FIG. 3A is a graph showing a 1 M change of a magnetic field at each step, and FIG. 3B is a table showing an average error amount for each step. Referring to FIGS. 3A and 3B, steps 2, 3, 4, and 5 are provided.

The steps are used to indicate that data is measured at predetermined intervals. For example, when data is measured at steps of 20 centimeter (cm) intervals, step 2 (i.e. 2 steps) may indicate that data is measured at 40 cm intervals, step 3 may indicate that the data is measured at 60 cm intervals, and step 4 may indicate that the data is measured at 80 cm intervals.

When a sampling interval of the user terminal corresponds to a 2.5 microtesla (μT) interval, a change in a magnetic field may be distinguished at a probability of 90% in a case of step 2, whereas the change in the magnetic field may be distinguished at a probability of 80% in a case of step 5, according to the graph of FIG. 3A.

Accordingly, when a threshold for an accuracy requested by a user is set to, for example, 90%, the data may be measured at a data sampling interval corresponding to step 2 satisfying the probability of 90%. As described above, the sampling interval for the target area may be determined

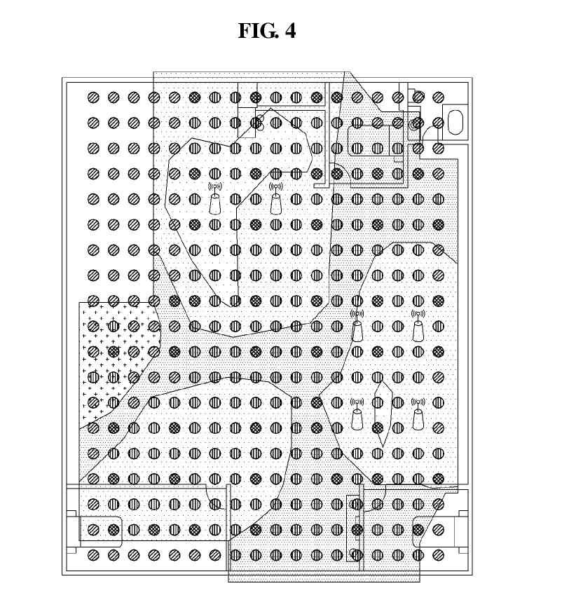

FIG. 4 illustrates an example of a magnetic field map.

Referring to FIG. 4, a result of associating a magnetic field map generated by the generating apparatus with a map of a target area and a plane of a building included in the target area is illustrated.

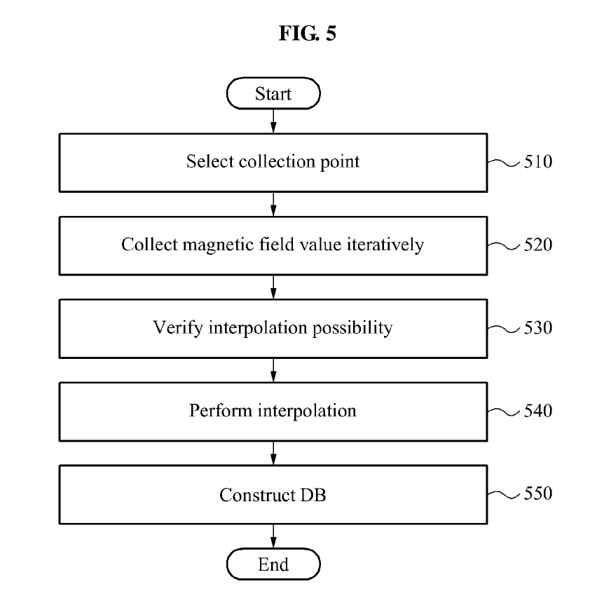

FIG. 5 illustrates an example of a scheme of constructing a DB based on a magnetic field value of a target area.

Referring to FIG. 5, in 510, collection point(s) are selected at which a magnetic field value for location estimation is to be collected. For example, the collection point may be selected through a floor plan of a target area, or the like.

In 520, a magnetic field value is collected in view of a structural characteristic of the collection point(s) selected in 510, for example, a room, a lobby, a passage, and the like, an indoor space arrangement, and the like. For example, the magnetic field value may be iteratively collected by changing a measurement height, a time, and the like, at an identical collection point, or may be iteratively collected at an identical height, an identical time, and the like.

In 530, an interpolation possibility that indicates whether the interpolation is performable is verified based on the magnetic field value collected in 520. For example, an apparatus performing the method may verify the interpolation possibility, based on a non-linearity of a currently measured data value.

The interpolation may obtain an inaccurate result when a value is significantly changed in a limited space. For example, when values of “1” and “10” are interpolated, a value of “5.5” may be obtained. However, when values of “1” and “1” are interpolated, a value of “1” may be obtained. In this example, an interpolation performable for a worst case may be used for all spaces. Accordingly, an advance interpolation possibility of the interpolation may be verified at a location at which a magnetic field value is maximally uniform.

In 540, interpolation with respect to the magnetic field value is performed, in response to the interpolation possibility being verified in 530.

A geomagnetic field disturbance model with respect to materials such as steel bars, pipes, electric wires, and the like, used for a building are yet to be defined and thus, mathematical prediction of a geomagnetic field value may be difficult. According to various aspects, however, the geomagnetic field value may be predicted by mathematical modeling using interpolation, as described below.

The interpolation may obtain an attribute value of an unknown area or point using an attribute value of a predetermined area or point. For example, interpolation may be used to obtain a value at a predetermined point between two points, using known values of the two points. The interpolation may induce a location value of a predetermined space between location coordinates positioned on a curved line.

For example, a high order interpolation among interpolations may require neighboring pixels to generate an output value. The interpolation functions may be performed based on the same principle. An interpolation function may be disposed in the center of a single point to be calculated, and values of sample points may be multiplied by samples. A sum of all calculated values may correspond to a value of intensity to be newly derived. For example, a cubic convolution interpolation may refer to a method of performing an interpolation, based on neighbor values using values of a 4×4 lattice as a window. The cubic convolution interpolation may apply a weight in both directions, thereby reducing an error when compared to other interpolations. In addition, the cubic convolution interpolation may increase a performance of an output value, however, it may also consume a relatively great amount of time for calculation, when compared to a bilinear interpolation.

According to various aspects, by applying various interpolations to the geomagnetic field value obtained in the target region, a disturbance and distortion of the geomagnetic field including a geomagnetic field characteristic of the target region may be interpolated properly.

In 550, a DB is constructed using a result of the interpolation performed in 540.

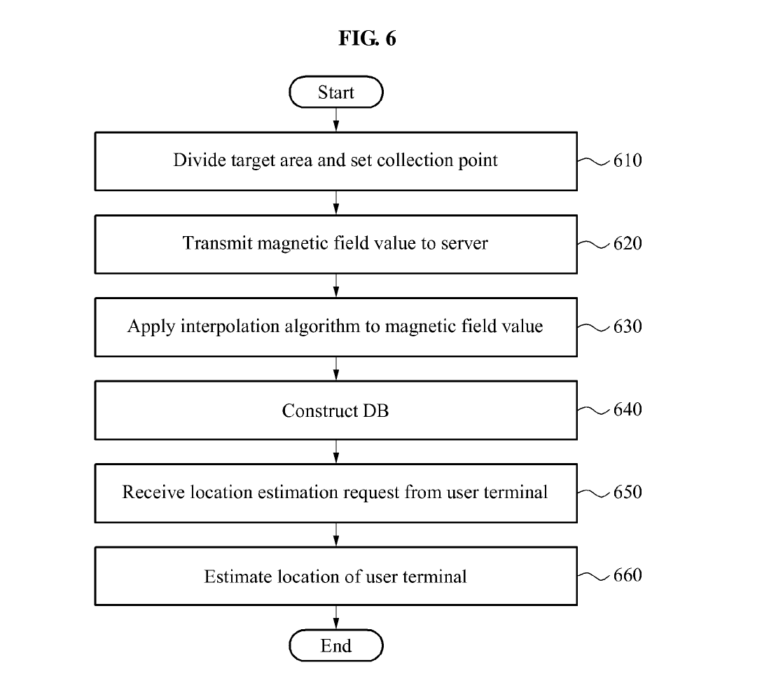

FIG. 6 illustrates an example of a method of estimating a location of a user terminal using a DB.

In this example, a server in communication with a terminal may construct a DB using a magnetic field value collected by the generating apparatus, and estimate a location of a user terminal using the constructed DB. However, it should be appreciated that another type of terminal may be used to construct a DV and estimate a location of a user terminal. For example, a computer, a smart phone, an appliance, a tablet, a navigation system, and the like.

Referring to FIG. 6, in 610, a target area corresponding to a space for location estimation is divided, and a point P at which a value, for example, an intensity of a geomagnetic field that is to be measured is set in the target area. Here, the point P may be referred to as a collection point.

In 620, a magnetic field value at the collection point is collected and the collected to magnetic field value is transmitted to the server. In 630, the server applies an interpolation algorithm to the magnetic field value obtained by the generating apparatus.

In 640, the server constructs a DB based on a predicted magnetic field value generated by the interpolation algorithm. According to various aspects, in order to increase a performance of a location estimating system using a geomagnetic field, the server may construct the DB using values that are close to actually measured values by reducing an amount of time used for constructing the DB and densely setting points at which magnetic field values are to be obtained.

In 650, the server receives a location estimation request from the terminal.

In 660, the server estimates a location of the terminal For example, the server may estimate a point at which a magnetic field value is most similar to a predicted magnetic field value stored in the constructed DB, to be the location of the terminal.

When the user terminal requests the server to provide a location estimation service after the DB is constructed, the server may compare measured data to predicted magnetic field values stored in the DB, and provide a most appropriate location value to the user terminal.

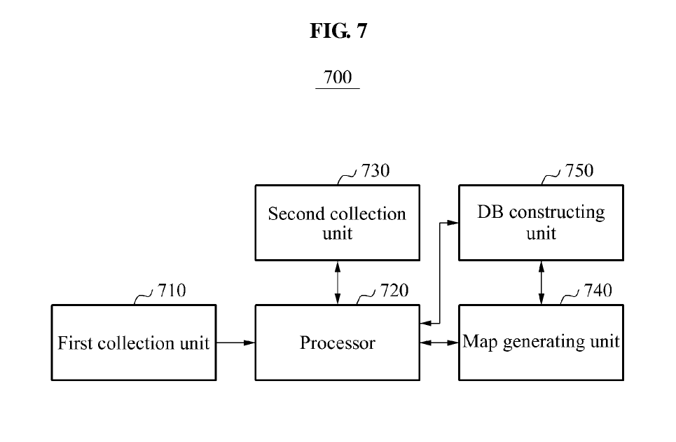

FIG. 7 illustrates an example of an apparatus 700 for generating a magnetic field map for DB construction. For example, the apparatus 700 may be or may be included in a terminal such as a server, a computer, a mobile phone, a navigation device, a tablet, and the like.

Referring to FIG. 7, the generating apparatus 700 includes a first collection unit 710, a processor 720, a second collection unit 730, a map generating unit 740, and a DB constructing unit 750.

The first collection unit 710 may collect a magnetic field value of a sample area corresponding to at least a portion of a target area. The magnetic field value may be used to verify a user location based on a geomagnetic field.

The processor 720 may verify a magnetic field characteristic of the sample area, using the magnetic field value of the sample area collected by the first collection unit 710, and determine a sampling interval for the target area based on the magnetic field characteristic of the sample area. The processor 720 may verify the magnetic field characteristic of the sample area based on a distribution of magnetic materials in the sample area.

In this example, the processor 720 may determine a horizontal sampling interval and a vertical sampling interval for the target area, based on the magnetic field characteristic of the sample area. As another example, the processor 720 may determine a collection point of a magnetic field value for the target area, based on the magnetic field characteristic of the sample area.

According to various aspects, the processor 720 may apply an interpolation algorithm to the magnetic field value of the sample area collected by the first collection unit 710, and predict magnetic field values for other areas in the target area, excluding the sample area, based on a result of the applying. For example, the magnetic field values of the other areas may be used by the map generating unit 740 for generating a magnetic field map.

The second collection unit 730 may collect a magnetic field value of the target area based on the sampling interval determined by the processor 720. The processor 720 may process the magnetic field value of the target area collected by the second collection unit 730 into data that is suitable for estimating the user location, and store the processed data in a DB. For example, the processor 720 may correct the collected magnetic field value of the target area collected by the second collection unit 730, based on a distribution of a magnetic permeability with respect to the target area.

The map generating unit 740 may generate a magnetic field map for DB construction, using the magnetic field value of the target area collected by the second collection unit 730.

The DB constructing unit 750 may associate the generated magnetic field map with a map of the target area and a building plan included in the target area, and may construct the DB based on a result of the associating.

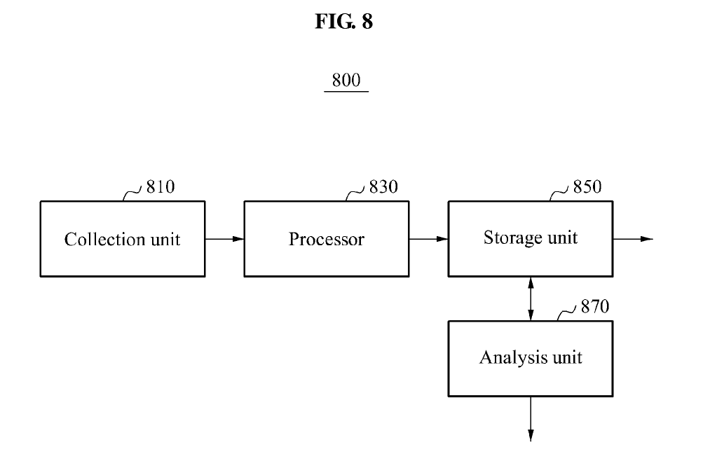

FIG. 8 illustrates another example of an apparatus 800 for generating a magnetic field map for DB construction. For example, the apparatus 800 may be or may be included in a terminal such as a server, a computer, a mobile phone, a navigation device, a tablet, and the like.

Referring to FIG. 8, the generating apparatus 800 includes a collection unit 810, a processor 830, a storage unit 850, and an analysis unit 870.

The collection unit 810 may collect a magnetic field value as data to be used to determine a user location. For example, the data collected by the collection unit 810 may include components of (X, Y, Z) values corresponding to geometric field components. In addition, the collected data may further include a magnetic field intensity, a change in a magnetic field, and the like. Geomagnetic field data obtained by a sensor may correspond to the components of (X, Y, Z) values.

The data collected by the collection unit 810 may be processed by the processor 830, and the like to derive a desired result. The collection unit 810 may collect a magnetic field value, using an IMU sensor, a geomagnetic sensor, and the like. For example, the magnetic field value may be obtained by setting, in a server, an image of a building plan to which a fingerprint location estimation algorithm is to be applied in a building for location estimation, determining a point at which a magnetic field value is to be actually obtained through the building plan of the building, and installing a sensor.

The data obtained by the sensor may be transmitted via a dedicated cable of the sensor, and the like, and stored in the collection unit 810. The collection unit 810 may store the data obtained by the sensor and transmit the data to the processor 830, thereby enabling a DB to be constructed for location determination.

The processor 830 may process the magnetic field value collected by the collection unit 810 into data that is suitable for estimating a location. The data processed by the processor 830 may be stored in the server configured to determine the user location, and the like, and may be used for correcting an error of a geomagnetic field value.

The processor 830 may predict a magnetic field value of an unmeasured point, by applying an interpolation to the collected magnetic field value. For example, the processor 830 may employ a bilinear interpolation, a one-dimensional interpolation, and the like, calculate a result of a curvilinear function, and use the result for data processing. In addition, the processor 830 may use a ferromagnetic material for data processing.

The processor 830 may process the components of (x, y, z) values collected by the collection unit 810 into a geomagnetic field value that is suitable for estimating the user location. For example, the processor 830 may calculate a geomagnetic field value based on initial (x, y, z) values of the data obtained by the sensor. Here, the calculated geomagnetic field value or an intensity of a geomagnetic field may be utilized as initial data for interpolation.

In this example, interpolation to be used may correspond to a task of standardizing data in a form of a predetermined polynomial expression, as described above. The interpolation may be used to estimate a point of which a value is yet to be obtained through observation and experiment. The interpolation may be suitable for estimating linear data, for example, a geomagnetic field. The geomagnetic field value estimated using the interpolation and the geomagnetic field value obtained by the sensor may be transferred to the storage unit 850.

The storage unit 850 may store the data processed by the processor 830 as data to be used for determining the location of a terminal. In addition, the storage unit 850 may store a map of the target area for which the location estimation service is to be provided, a building plan included in the target area, and the like.

The storage unit 850 may store the geomagnetic field value in the image of the plan of the building in the server. For example, the geomagnetic field values may be divided based on a horizontal axis and a vertical axis of the building, and stored.

In this example, the horizontal axis of the building may indicate a geomagnetic field value that is to be matched to the map or the image of the plan for location determination, and the vertical axis of the building may indicate a geomagnetic field value according to height. When a distribution of the geomagnetic field value of the horizontal axis is uniform, the location may be estimated using the geomagnetic field value according to height.

In a case of a geomagnetic field, notable attenuation may occur when a distance from a core of the Earth increases. For example, although data are obtained at an identical point, a value, for example, an intensity, of the geomagnetic field value may be changed due to a difference of several centimeters in terms of height. Accordingly, the magnetic field value according to the heights may be definitely considered when the magnetic field map is constructed. According to various aspects, the apparatuses described herein may determine both a three-dimensional location of a terminal with respect to the height of a building or other space in which a terminal is located.

The analysis unit 870 may analyze the data stored in the storage unit 850 when the user requests location estimation, thereby determining location candidates estimated as the user location. In this example, the analysis unit 870 may calculate a similarity distribution of magnetic field values, using the data stored in the storage unit 850 and the data measured by the user terminal, and determine the location candidates estimated as the user location.

The analysis unit 870 may store data that is accumulated by performing the location estimation and the location determination iteratively, thereby also performing data collection for the DB. The analysis unit 870 may estimate the location of the user terminal for the location service.

For example, when a geomagnetic field value of the user terminal requesting the location estimation is received, the analysis unit 870 may attempt to match the geomagnetic field value transmitted from the user terminal to all geomagnetic field values stored in the storage unit 850. The analysis unit 870 may transmit plan information to the user terminal based on a location estimation value determined as a result of the matching, and may schematize the location estimation value. The analysis unit 870 may convert the geomagnetic field value transmitted from the user terminal into data, analyze the data, and update the data continuously.

According to various aspects, a terminal can determine, or otherwise request a server to determine a location of the terminal using a two-dimensional or three-dimensional geomagnetic map. Magnetic field information from a target area can be sensed by the terminal and can be used to determine a magnetic field map. The magnetic field map can also be determined based on a building plan, and the like. Thus, the determined magnetic field map can accommodate for changes in magnetic field due to metallic objects located within a structure or building that are disposed around a terminal

According to various aspects, a sample area can be set inside of a target area. The collection area can be sensed to determine magnetic field properties of the sample area. Those areas of the target area that are not sampled, can have magnetic field properties estimated, for example, through interpolation of the magnetic field properties of the sample area.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of generating a magnetic field map, the method comprising:
collecting a magnetic field value of a sample area comprising at least a portion of a target area;
verifying a magnetic field characteristic of the sample area based on the magnetic field value of the sample area;
determining a sampling interval for the target area based on the magnetic field characteristic of the sample area;
collecting a magnetic field value of the target area at the sampling interval; and
generating a magnetic field map based on the collected magnetic field value of the target area.

2. The method of claim 1, wherein the verifying comprises verifying the magnetic field characteristic of the sample area based on magnetic materials that are included in the sample area.

3. The method of claim 1, wherein the determining comprises determining a horizontal sampling interval and a vertical sampling interval for the target area, based on the magnetic field characteristic of the sample area.

4. The method of claim 1, wherein the determining comprises determining a collection point of a magnetic field value for the target area, based on the magnetic field characteristic of the sample area.

5. The method of claim 1, further comprising:
performing an interpolation algorithm on the magnetic field value of the sample area; and
predicting magnetic field values for other portions of the target area, excluding the sample area, based on the interpolation.

6. The method of claim 5, wherein the generating further comprises generating the magnetic field map based on the magnetic field values of the other portions of the target area.

7. The method of claim 1, further comprising:
processing the collected magnetic field value of the target area into data that is suitable for estimating the user location; and
storing the processed data in a database.

8. The method of claim 1, further comprising:
correcting the collected magnetic field value of the target area based on a distribution of a magnetic permeability with respect to the target area.

9. The method of claim 1, further comprising:
applying the generated magnetic field map to a map of the target area and a building plan included in the target area; and
constructing a database based on a result of the applying.

10. The method of claim 1, wherein the collecting of the magnetic field value of the sample area comprises:
setting a point at which to collect a magnetic field value, in the sample area of the target area; and
collecting the magnetic field value of the sample area at the set point.

11. A non-transitory computer-readable medium comprising a program for instructing a computer to perform the method of claim 1.

12. An apparatus for generating a magnetic field map, the apparatus comprising:
a first collection unit configured to collect a magnetic field value of a sample area comprising at least a portion of a target area;
a processor configured to verify a magnetic field characteristic of the sample area based on the magnetic field value of the sample area, and to determine a sampling interval for the target area based on the magnetic field characteristic of the sample area;
a second collection unit configured to collect a magnetic field value of the target area based on the sampling interval; and
a map generating unit configured to generate a magnetic field map based on the collected magnetic field value of the target area.

13. The apparatus of claim 12, wherein the processor is configured to verify the magnetic field characteristic of the sample area based on magnetic materials that are included in the sample area.

14. The apparatus of claim 12, wherein the processor is configured to determine a horizontal sampling interval and a vertical sampling interval for the target area, based on the magnetic field characteristic of the sample area.

15. The apparatus of claim 12, wherein the processor is configured to determine a collection point of a magnetic field value for the target area, based on the magnetic field characteristic of the sample area.

16. The apparatus of claim 12, wherein the processor is configured to perform an interpolation algorithm on the magnetic field value of the sample area, and to predict magnetic field values for other portions of the target area, excluding the sample area, based on a result of the interpolation.

17. The apparatus of claim 16, wherein the map generating unit is configured to further generate the magnetic field map based on the magnetic field values of the other areas.

18. The apparatus of claim 12, wherein the processor is configured to process the collected magnetic field value of the target area into data that is suitable for estimating the user location, and to store the processed data in a database.

19. The apparatus of claim 12, wherein the processor is configured to correct the collected magnetic field value of the target area based on a distribution of a magnetic permeability with respect to the target area.

20. The apparatus of claim 12, further comprising:
a database (DB) constructing unit configured to apply the generated magnetic field map to a map of the target area and a building plan included in the target area, and to construct a database based on a result of the applying.
